(19) United States
(12) Patent Application Publication
(10) Pub. No.: US 2013/0275483 A1
(43) Pub. Date: Oct. 17, 2013

(54) FILTER SYSTEM

(71) Applicants: Tamas Bako, Budapest (HU); Thomas Borger, Klein-Zimmern (DE); Gergo Ladanyi, Miskolc (HU); Tamas Szigethy, Budapest (HU)

(72) Inventors: Tamas Bako, Budapest (HU); Thomas Borger, Klein-Zimmern (DE); Gergo Ladanyi, Miskolc (HU); Tamas Szigethy, Budapest (HU)

(21) Appl. No.: 13/859,913

(22) Filed: Apr. 10, 2013

(30) Foreign Application Priority Data
Apr. 12, 2012 (EP) 12163968.6

(51) Int. Cl. G06F 17/10

(52) U.S. Cl. CPC G06F 17/10
USPC 708/300

(57) ABSTRACT

A filter system with infinite impulse response is provided. The filter system has a transfer function that includes at least one pair of first order polynomial fractions. In one embodiment, the poles and/or the zeros of the pair of polynomial fractions are complex conjugates, respectively. The gain of the transfer function is realized, for example, by virtue of at least two separate multiplier elements

### CROSS REFERENCE TO RELATED APPLICATIONS

The present application claims priority to European Patent Office application No. 12163968.6 EP filed Apr. 12, 2012, the entire content of which is hereby incorporated herein by reference.

### FIELD OF INVENTION

The invention concerns a filter system with infinite impulse response.

### BACKGROUND OF INVENTION

Infinite impulse response (IIR) filters are popular in digital signal processing. They are characterized by an impulse response function that is non-zero over an infinite length of time. IIR filters can be defined through a transfer function that is a mathematical representation in terms of spatial or temporal frequency, of the relation between the input and output signal of the filter.

In the case of a digital filter, the transfer function can be expressed in the z-domain as:

$$H ( z ) = {K}_{tot} \cdot \frac{{b}_{0} + {b}_{1} {z}^{- 1} + … + {b}_{N} {z}^{N}}{{a}_{0} + {a}_{1} {z}^{- 1} + … + {a}_{M} {z}^{- M}} ,$$

where a and b are the coefficients of the polynomials in the numerator and denominator, and K is the overall gain. (In the case of the direct realization, a and b are the coefficients of the created filter as well.) The technical realization of an IIR filter with a given transfer function is straightforward and can be done by means of well-known evaluations of the transfer function such as e.g. Direct Form I or Direct Form II.

Compared to finite impulse response (FIR) filters, IIR filters feature a small memory consumption and small calculational demand. One disadvantage of them is that—due to sensitivity for quantization and calculation errors—in certain cases the output of an IIR filter can become noisy, inaccurate or the filter can become unstable.

### SUMMARY OF INVENTION

The problem that the present invention attempts to solve is therefore creating a filter system that has a particularly low sensitivity in the numerical representation of filter coefficients.

This problem is inventively solved by a filter system, wherein the transfer function of the filter system comprises at least one pair of first order polynomial fractions.

The invention is based on the consideration that high order polynomials are sensitive to the representation accuracy of their coefficients. Small inaccuracies in the coefficients lead to large changes in the roots of the polynomials, hence the shape of the polynomial and the filter characteristic itself will strongly change.

The sensitivity of the polynomial at a given point for small perturbations in the coefficient can be characterized by the derivative of the polynomial (more information can be read about this e.g. in P. Guillaume, J. Schoukens and R. Pintelon, “Sensitivity of Roots to Errors in the Coefficient of Polynomials Obtained by Frequency-Domain Estimation Methods,” IEEE Trans. on Instr. and Meas. vol. 38, pp. 1050-1056, December 1989.). If the derivative is small, the polynomial is very sensitive at that point. If the polynomial is expressed as

$$p ( z ) = {\prod }_{i = 1}^{N} ( {z}^{- 1} - {r}_{i} ) = {b}_{0} + … + {b}_{N} {z}^{- N} ,$$

then the derivative is

$$\frac{d p ( z )}{d z} = \frac{{\prod }_{i = 1}^{N} ( {z}^{- 1} - {r}_{i} )}{( {z}^{- 1} - {r}_{1} )} + … + \frac{{\prod }_{i = 1}^{N} ( {z}^{- 1} - {r}_{i} )}{( {z}^{- 1} - {r}_{N} )} ,$$

where r is one root of the polynomial (if it belongs to the numerator, it will be the zero of the filter, if it belongs to the denominator it is the pole of the filter). This formula can be very small—hence the shape of the polynomial can be sensitive—if the roots are close together and the polynomial order is high. This is typical at high filter orders and when the filter corner frequency is low or the filter bandwidth is small (compared to the sampling frequency).

Inaccuracy of coefficients happens since the numerical representation of them has finite length. E.g. the IEEE 754 single precision floating-point format is only 7 digits accurate. Theoretically, the accuracy of the coefficients can be increased e.g. by using IEEE 754 double precision or quadruple precision. However, today's digital signal processors support only single precision calculations.

The following list shows some examples for the inaccuracy:

A 10^{th} order Butterworth low-pass or high-pass filter, with IEEE 754 double precision calculations, becomes extremely inaccurate (more than 0.5 dB inaccuracy in the pass-band), if the corner frequency is lower than the 1/50-th part of the sampling frequency.

A 10^{th} order Butterworth low-pass or high-pass filter, with IEEE 754 single precision calculations, becomes extremely inaccurate (more than 0.5 dB inaccuracy in the pass-band), if the corner frequency is lower than the 1/10-th part of the sampling frequency.

A 2^{nd} order Butterworth low-pass or high-pass filter, with IEEE 754 single precision calculations becomes extremely inaccurate (more than 0.5 dB inaccuracy in the pass-band), if the corner frequency is lower than 1/1000-th part of the sampling frequency.

Splitting the original filter transfer function to the multiplicatives of smaller polynomial fractions efficiently decreases the sensitivity of the characteristic to numerical inaccuracies. One solution is to split the original transfer function into second order sections because calculations there will not be too difficult (cascaded biquad filters). However, as the last example above shows, sometimes this is not enough.

A better realization than traditional second order sections which has the smallest sensitivity for numerical inaccuracies in coefficients can be achieved by using cascaded first order polynomial fractions:

$${H}_{1} ( z ) = {K}_{1} \cdot \frac{{z}^{- 1} - c}{{z}^{- 1} - d} = {K}_{1} \cdot \frac{{z}^{- 1} - ( y + j δ )}{{z}^{- 1} - ( α + j β )} ,$$

where j is the imaginary unit, i.e. the square root of −1. The derivative of a first order polynomial is always around 1. Hence the filter constructed from these first order polynomial fractions will become very stable.

Generally, this requires many calculations with complex numbers. The overall filter structure can be further simplified by arranging the polynomial roots into complex conjugate pairs, i.e. advantageously the poles and/or the zeros of the pair of polynomial fractions are complex conjugates, respectively:

$${H}_{2} ( z ) = {K}_{2} \cdot \frac{{z}^{- 1} - ( y + jδ )}{{z}^{- 1} - ( α + j β )} \cdot \frac{{z}^{- 1} - ( y - j δ )}{{z}^{- 1} - ( α - j β )} ,$$

wherein α, β, γ, δ are real numbers. In this case—for real input signals, of course—a second order block always has real input and real output that simplifies calculations. This forms a new second order filter structure.

Furthermore, the gain of the transfer function is advantageously realized by virtue of at least two separate multiplier elements, i.e. a split gain. This realization makes sense at fixed point realization. In this case the value range of internal variables will be the same (this is not required when using floating point calculations). E.g. in the case of structures for floating point realization, transients can be minimized by multiplying the internal variable at the first delay by the square root of gain change, and multiplying the internal variables at the second and third delays by the gain change.

The structure further simplifies, if the value of zeros of the pair of polynomial fractions is advantageously −1 or 1. Here, multiplier elements for the numerator of the polynomial fractions can be eliminated. This happens in the case of low-pass or high-pass Butterworth filter realizations.

In a further advantageous embodiment, the transfer function of the filter systems consists of cascaded pairs of first order polynomial fractions and at most one single first order polynomial fraction, wherein the poles and the zeros of each pair of polynomial fractions are complex conjugates, respectively. This provides a particularly advantageous way of creating higher order filter structures with the proposed filter structure by cascading the second order filter structures. Odd order filter structures can be created by cascading a first order filter to the cascaded second order structures.

The advantages achieved by the invention comprise particularly the creation of a new, second order IIR filter structure that is stable and has high accuracy on extreme low frequencies as well. The original filter transfer function is split into first order fraction parts. These fraction parts are complex conjugates. The new filter structure is created by realizing these parts assuming real (not complex) input and output signals. The coefficients of the filter are simply the real and imaginary part of the poles and zeros. The proposed new filter structure has extremely small output transients at filter coefficient change.

### BRIEF DESCRIPTION OF THE DRAWINGS

Embodiments of the invention are explained in more detail in the following figures.

FIG. 1 shows a realization of a first order filter with one complex pole and one complex zero,

FIG. 2 shows a possible realization of the proposed filter structure with complex conjugate pole and zero pairs for real input and output,

FIG. 3 shows another possible realization with the K overall gain split in two pieces,

FIG. 4 shows a second order high-pass Butterworth filter realization with the proposed filter structure,

FIG. 5 shows a second order low-pass Butterworth filter realization with the proposed filter structure,

FIG. 6 shows a modified Butterworth filter structure for fixed point implementation with split gain,

FIG. 7 shows a graph of the characteristics of the proposed filter structure and a usual Direct Form I structure,

FIG. 8 shows a graph of the total harmonic distortion plus noise (THD+N) of the proposed filter structure and a usual Direct Form I structure at several corner frequencies,

FIG. 9 shows a graph of the corner frequency switching transients of a second order low-pass Butterworth filter, realized with the proposed filter structure, in the case of a DC input signal (sampling freq is 48 kHz), and

FIG. 10 Corner frequency switching transients of a 2^{nd} order LP Butterworth filter, realized with the new filter structure, in the case of 5 Hz sinusoid input signal (sampling freq is 48 kHz).

### DETAILED DESCRIPTION OF INVENTION

Equal parts have the same reference numerals in all FIGs.

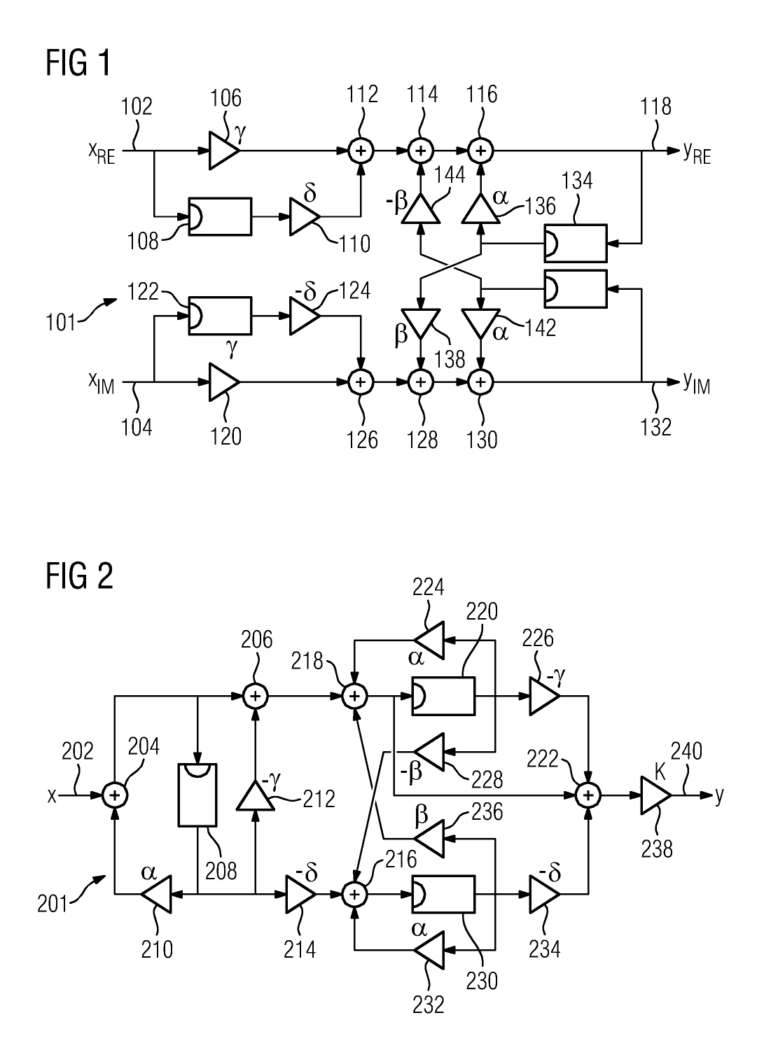

FIG. 1 shows a straightforward realization of a first order filter with one complex pole and one complex zero with the transfer function:

$${H}_{1} ( z ) = {K}_{1} \cdot \frac{{z}^{- 1} - c}{{z}^{- 1} - d} = {K}_{1} \cdot \frac{{z}^{- 1} - ( y + jδ )}{{z}^{- 1} - ( α + j β )} .$$

The block diagram according to FIG. 1 shows a filter system 101 with split real input 102 and imaginary input 104. The real input 102 is fed in parallel into a multiplier 106 with value γ and a delay 108 with serially connected multiplier 110 with value −δ. The signal from multipliers 106 and 110 are fed into adder 112 and from there serially into adders 114 and 116, the latter's signal then forming the real output 118 of the filter.

Equally, the imaginary input 104 is fed in parallel into a multiplier 120 with value γ and a delay 122 with serially connected multiplier 124 with value −δ. The signal from multipliers 120 and 124 are fed into adder 126 and from there serially into adders 128 and 130, the latter's signal then forming the imaginary output 132 of the filter.

The real 118 output is fed into a further delay 134 and from there split into multiplier 136 with value a leading to adder 116 and multiplier 138 with value β leading to adder 128. Equally, the imaginary output 132 is fed into a further delay 140 and from there split into multiplier 142 with value a leading to adder 130 and multiplier 144 with value −β leading to adder 114.

FIG. 2 shows a possible realization of the proposed filter structure with complex conjugate pole and zero pairs for real input and output based on the transfer function:

$${H}_{2} ( z ) = {K}_{2} \cdot \frac{{z}^{- 1} - ( y + j δ )}{{z}^{- 1} - ( α + j β )} \cdot \frac{{z}^{- 1} - ( y - j δ )}{{z}^{- 1} - ( α - j β )} .$$

The block diagram according to FIG. 2 shows a filter system 201 with real input 202, fed into adder 204. Adder 204's output is split into adder 206 and delay 208. The output of delay 208 is split into multiplier 210 with value a leading to adder 204, multiplier 212 with value −γ leading to adder 206 and multiplier 214 with value −δ leading to adder 216.

Adder 206's output is fed into adder 218 and further split into delay 220 and adder 222. The output signal of delay 220 is split into multiplier 224 with value α leading to adder 218, multiplier 226 with value −γ leading to adder 222 and multiplier 228 with value −β leading to adder 216. Adder 216′s output is fed into delay 230. The output signal of delay 230 is split into multiplier 232 with value α leading to adder 216, multiplier 234 with value −δ leading to adder 222 and multiplier 236 with value β leading to adder 218. The output of adder 222 is fed into multiplier 238 with value K (the gain of filter system 201) whose output forms the real output 240 of the filter system 201.

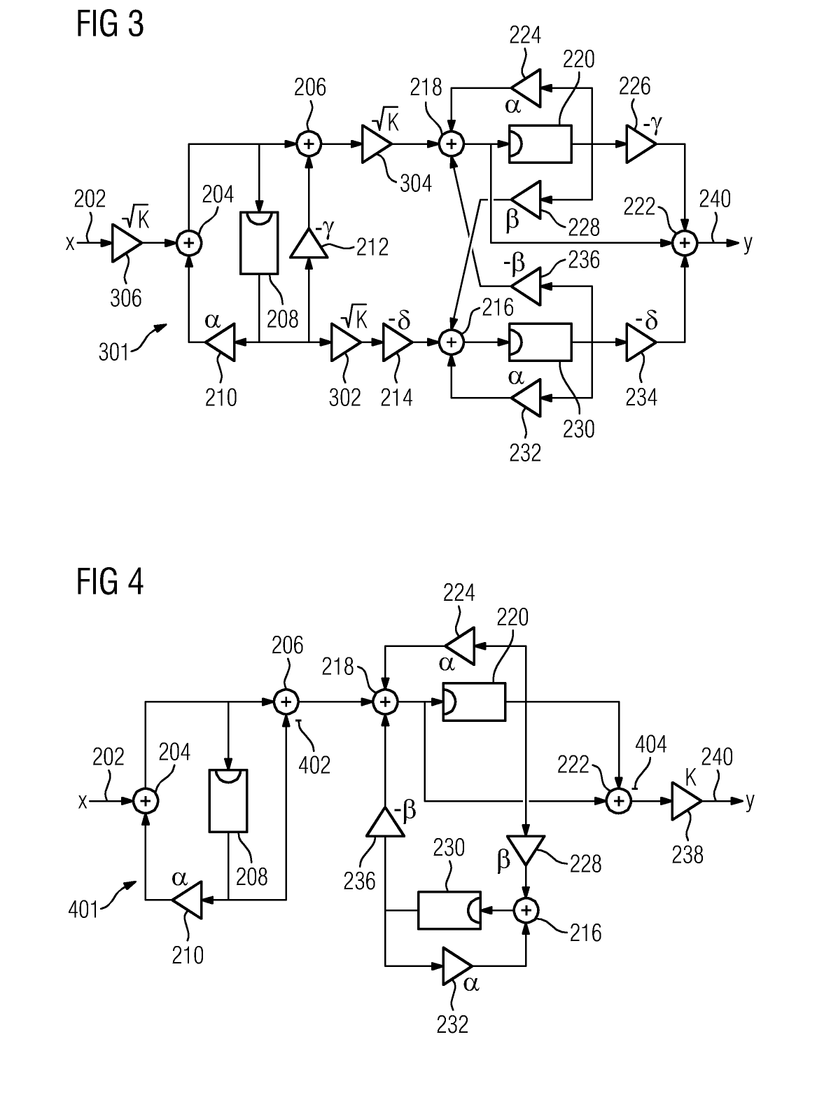

FIG. 3 shows another possible realization of the filter structure according to FIG. 2 with split gain. The block diagram of filter system 301 according to FIG. 3 is similar to that of FIG. 2 and is merely explained regarding the differences to FIG. 2.

In filter system 301, multiplier 238 of FIG. 2 is removed and replaced by multiplier 302 with value sqrt(K) immediately before multiplier 214, multiplier 304 with value sqrt(K) immediately before adder 218 and multiplier 306 with value sqrt(K) right before adder 204. As described above, this realization makes sense at fixed point realization. In this case the value range of internal variables will be the same (this is not required at floating point calculations).

The structure further simplifies, if the value of zeros are −1 or 1, i.e. δ=γ=0. This happens in the case of low-pass or high-pass Butterworth filter realizations.

The block diagram according to FIG. 4 shows a second order high-pass Butterworth filter system 401 with the proposed filter structure. FIG. 4 equals to FIG. 2 with δ=0, i.e. multipliers 214 and 234 and their signal paths removed and γ=1, i.e. multipliers 212 and 226 replaced by simple negations 402 and 404.

The block diagram according to FIG. 5 shows a second order low-pass Butterworth filter system 501 with the proposed filter structure. FIG. 5 equals to FIG. 4 with the negations 402, 404 removed because γ=−1.

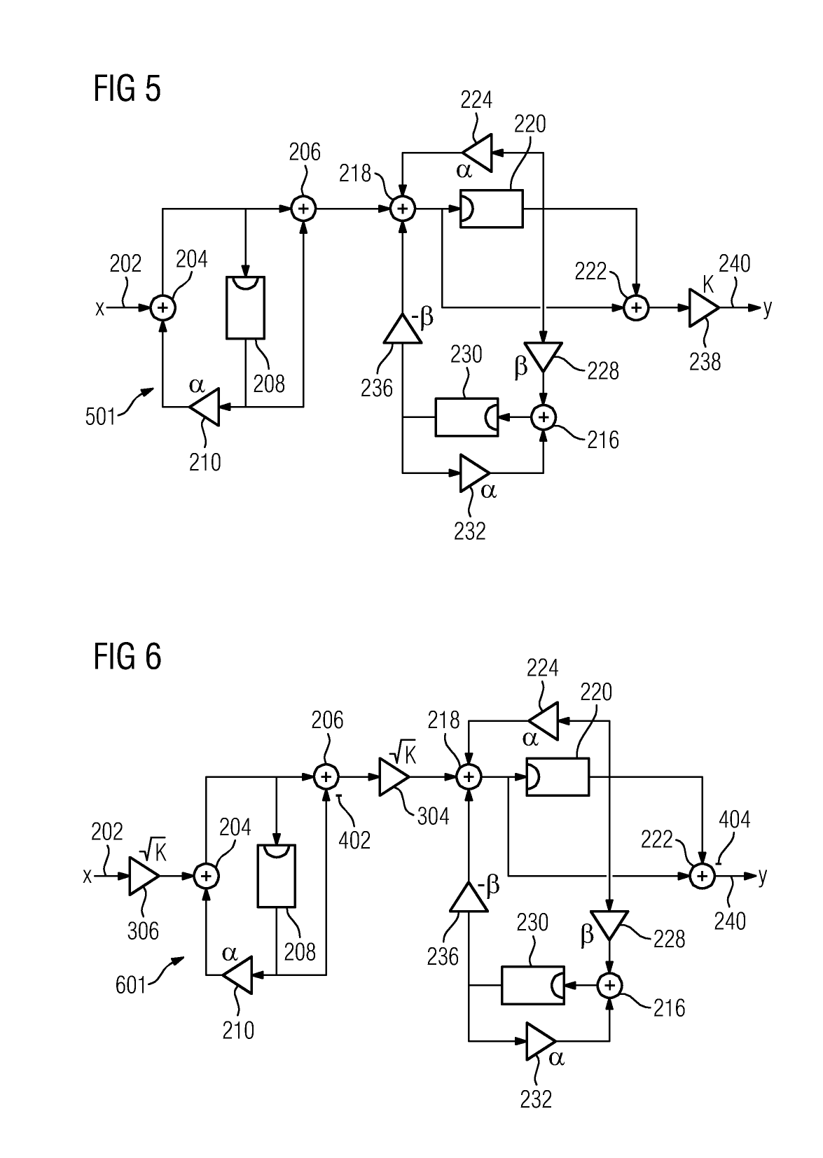

The block diagram according to FIG. 6 shows a modified high-pass Butterworth filter system 601 for fixed point implementation with split gain. FIG. 6 equals to FIG. 3 with δ=0, i.e. multipliers 214 and 234 and their signal paths removed and γ=1, i.e. multipliers 212 and 226 replaced by simple negations 402 and 404.

The shown filter structures 101, 201, 301, 401, 501, 601 provide a particularly advantageous way of creating higher order filter structures by cascading the second order filter structures 201, 301, 401, 501, 601 in arbitrary selection and number. Odd order filter structures can be created by cascading a first order filter to the cascaded second order filter systems 201, 301, 401, 501, 601.

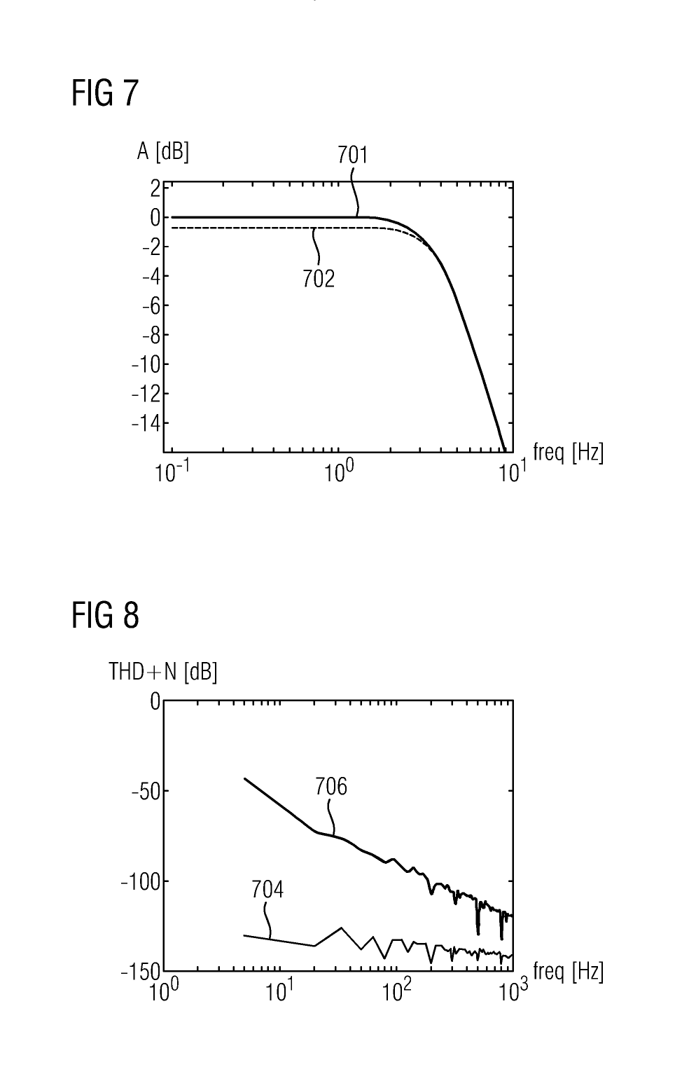

The new filter structure has much better accuracy on low corner frequencies, or when the filter bandwidth is small. Comparison of characteristics of the traditional, direct form I filter and the proposed filter structure—by using only single precision calculations—can be seen in FIG. 7. The noise behavior can be seen in FIG. 8. Here, a Direct Form I structure is used for comparison, because it is more stable than Direct Form II.

FIG. 7 shows the characteristics in a graph with the amplitude change A in unit dB plotted against the frequency freq in unit Hz. Line 701 shows the proposed filter structure and line 702 the Direct Form I structure. The realized characteristic is a second order Butterworth low-pass filter, the corner frequency is at 4 Hz, the sampling frequency is at 48 kHz.

The graph according to FIG. 8 shows the THD+N in unit dB of the proposed filter structure (line 704) and Direct Form I structure (line 706) plotted against the corner frequencies freq in unit Hz. The realized characteristic is a second order Butterworth low-pass filter with sampling frequency 48 kHz.

The proposed filter structure has a very good transient behavior as well. Traditional filter structures (e.g. Direct Form II or Lattice) can make strong transients when the corner frequency of the filter is changed during filtering. In the case of the proposed filter structure made for fixed point realization (split gain), transients are very small at coefficient changes.

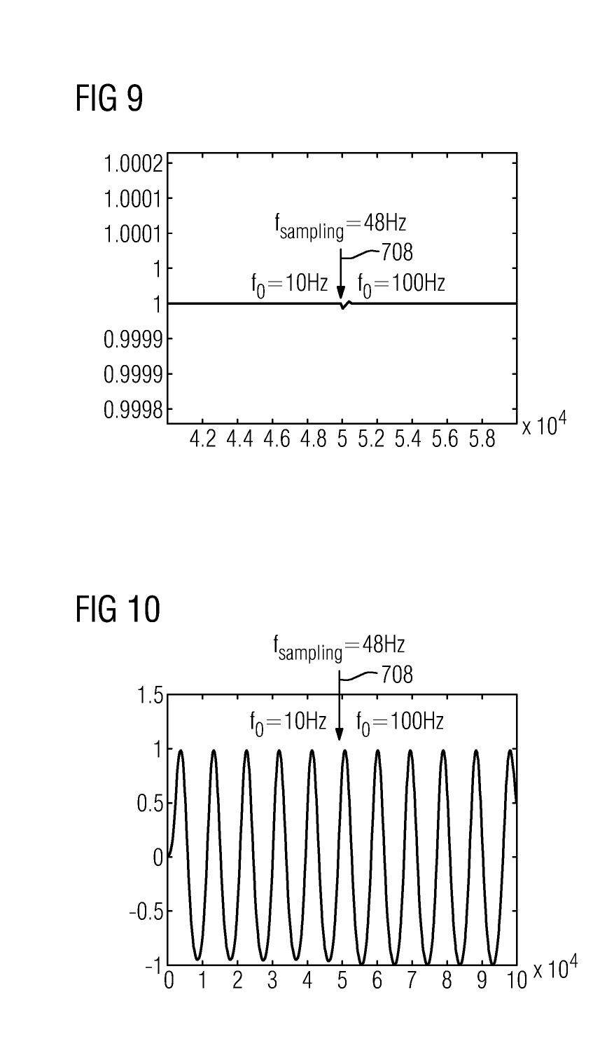

In FIGS. 9 and 10 the filter transients, i.e. the output signals can be seen, when a second order low pass Butterworth filter according to the proposed filter structure is switched from 10 Hz corner frequency to 100 Hz corner frequency. The input in FIG. 9 is a DC signal, in FIG. 10 it is a 5 Hz sinusoid. The signals are plotted against time, the change of corner frequency happens at arrow 708 and the sampling frequency in both cases is 48 kHz. The transient caused by the one decade change in corner frequency is negligibly small.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

### List of Reference Numerals

101 filter system
102 real input
104 imaginary input
106 multiplier
108 delay
110 multiplier
112, 114, 116 adder
118 real output
104 imaginary input
120 multiplier
122 delay
124 multiplier
126, 128, 130 adder
132 imaginary output
134 delay
136, 138 multiplier
140 delay
142, 144 multiplier
201 filter system
202 real input
204, 206 adder
208 delay
210, 212, 214 multiplier
216, 218 adder
220 delay
222 adder
224, 226, 228 multiplier
230 delay
232, 234, 236,238 multiplier
240 real output
301 filter system
302, 304, 306 multiplier
401 filter system
402, 404 negation
501, 601 filter system
701, 702, 704,706 line
708 arrow

1. A filter system with infinite impulse response,
the filter system having a transfer function that comprises at least one pair of first order polynomial fractions.

2. The filter system of claim 1, wherein the poles and/or the zeros of the pair of polynomial fractions are complex conjugates, respectively.

3. The filter system of claim 1, wherein the gain of the transfer function is realized by virtue of at least two separate multiplier elements.

4. The filter system of claim 1, wherein the value of the zeros of the pair of polynomial fractions is 1 and −1.

5. The filter system of claim 1, wherein the transfer function of the filter systems consists of cascaded pairs of first order polynomial fractions and at most one single first order polynomial fraction, wherein the poles and the zeros of each pair of polynomial fractions are complex conjugates, respectively.

6. An electronic device, comprising:
a filter system according to claim 1.
